(19) United States
(12) Patent Application Publication
(10) Pub. No.: US 2025/0379632 A1
(43) Pub. Date: Dec. 11, 2025

(54) COMMUNICATION APPARATUS AND COMMUNICATION METHOD

(71) Applicant: SONY GROUP CORPORATION, TOKYP (JP)

(72) Inventors: KANON SASAKI, TOKYO (JP); HAO WANG, TOKYO (JP); KENTA ASAKURA, TOKYO (JP); JUNGO GOTO, TOKYO (JP)

(21) Appl. No.: 18/877,995

(22) PCT Filed: May 26, 2023
(86) PCT No.: PCT/JP2023/019603

§ 371 Date: Dec. 20, 2024

(30) Foreign Application Priority Data
Jun. 29, 2022 (JP) 2022-104781

(51) Int. Cl. H04B 7/06; H04B 7/08; H04W 16/18; H04W 16/28

(52) U.S. Cl. CPC H04B 7/0639; H04B 7/0802; H04W 16/18; H04W 16/28

(57) ABSTRACT

A communication apparatus includes a communication unit and a control unit. The communication unit forms a beam and performs communication with another communication apparatus. The control unit acquires identification information of the beam used for the communication with the another communication apparatus. The control unit displays radiation information regarding at least one of a radiation angle or a radiation direction of the beam corresponding to the identification information on a display apparatus.

### FIELD

The present disclosure relates to a communication apparatus and a communication method.

### BACKGROUND

A recent wireless communication environment is facing a problem of exhaustion of radio resources due to a rapid increase in data traffic. Therefore, as one of measures to expand radio resources, in 5G, it has been studied to implement large-capacity communication such as 10 to 20 Gbps by broadband transmission using a frequency band higher than 4G (Long Term Evolution (LTE)). However, since radio wave propagation attenuation is large in a high frequency band, the coverage (communicable area) of the base station is narrower than in a case where a low frequency band is used.

In order to cancel the magnitude of radio wave propagation attenuation in a high frequency band, communication using a beam (or a beam pattern) has been studied. In order to select an optimal beam to be used for communication, beam sweeping may be performed in which each of a plurality of usable beams is used to transmit or receive a measurement signal (known signal).

In the beam sweeping, for example, if the body of the user is a shielding object of the beam, the beam cannot be appropriately measured, and an optimal beam may not be selected. Therefore, for example, there is known a technique of notifying a user of a measurement antenna and urging the user to move, thereby suppressing the user from being a beam shielding object.

### CITATION LIST

### Patent Literature

Patent Literature 1: JP 2020-127196 A

### SUMMARY

### Technical Problem

One antenna module can form a plurality of beams. However, in the above-described technology, a notification of the antenna module used for measurement and the measurement result is provided to the user in order to select the optimal beam, but a notification of the beam formed by the antenna module is not provided to the user.

By notifying the user of the information regarding the beam formed by the antenna module, the user can further improve the quality of communication using the beam.

Therefore, the present disclosure provides a mechanism capable of further improving the quality of communication using a beam.

Note that the above problem or object is merely one of a plurality of problems or objects that can be solved or achieved by the plurality of embodiments disclosed in the present specification.

### Solution to Problem

A communication apparatus of the present disclosure includes a communication unit and a control unit. The communication unit forms a beam and performs communication with another communication apparatus. The control unit acquires identification information of the beam used for the communication with the another communication apparatus. The control unit displays radiation information regarding at least one of a radiation angle or a radiation direction of the beam corresponding to the identification information on a display apparatus.

### BRIEF DESCRIPTION OF DRAWINGS

FIG. 1 is a diagram for explaining an example of a terminal apparatus according to the technology of the present disclosure.

FIG. 2 is a block diagram illustrating an example of a schematic configuration of a terminal apparatus according to an embodiment of the present disclosure.

FIG. 3 is a table illustrating an example of beam radiation information according to an embodiment of the present disclosure.

FIG. 4 is a diagram illustrating an example of a display image displayed by a display control unit according to an embodiment of the present disclosure.

FIG. 5 is a diagram illustrating another example of the display image displayed by the display control unit according to an embodiment of the present disclosure.

FIG. 6 is a diagram illustrating another example of the display image displayed by the display control unit according to an embodiment of the present disclosure.

FIG. 7 is a diagram illustrating a configuration example of an information processing system according to an embodiment of the present disclosure.

FIG. 8 is a block diagram illustrating a configuration example of an information processing apparatus according to an embodiment of the present disclosure.

FIG. 9 is a diagram for explaining an example of a radiation angle estimated by the information processing apparatus according to an embodiment of the present disclosure.

FIG. 10 is a diagram for explaining an example of estimation of a radiation angle by the information processing apparatus according to an embodiment of the present disclosure.

FIG. 11 is a diagram for explaining an example of estimation of a radiation angle by the information processing apparatus according to an embodiment of the present disclosure.

FIG. 12 is a diagram illustrating an example of an EIRP acquired by the information processing apparatus according to an embodiment of the present disclosure.

FIG. 13 is a diagram for explaining an example of a third generation method according to an embodiment of the present disclosure.

FIG. 14 is a diagram for explaining an example of a fourth generation method according to an embodiment of the present disclosure.

FIG. 15 is a flowchart illustrating an example of a flow of generation processing according to an embodiment of the present disclosure.

FIG. 16 is a flowchart illustrating an example of a flow of display processing according to an embodiment of the present disclosure.

FIG. 17 is a diagram illustrating an example of an image displayed on a display unit by a terminal apparatus according to an application example of an embodiment of the present disclosure.

FIG. 18 is a diagram illustrating another example of an image displayed on a display unit by a terminal apparatus according to an application example of an embodiment of the present disclosure.

FIG. 19 is a diagram illustrating another example of an image displayed on a display unit by a terminal apparatus according to an application example of an embodiment of the present disclosure.

FIG. 20 is a diagram illustrating another example of an image displayed on a display unit by a terminal apparatus according to an application example of an embodiment of the present disclosure.

### DESCRIPTION OF EMBODIMENTS

Hereinafter, embodiments of the present disclosure will be described in detail with reference to the accompanying drawings. Note that, in the present specification and the drawings, substantially the same elements are denoted by the same reference signs, and redundant description will be omitted. In addition, similar components may be distinguished by attaching different alphabets after the same reference signs. However, in a case where it is not necessary to particularly distinguish each of similar components, only the same reference sign is assigned.

Furthermore, in the present specification and the drawings, specific values may be indicated and described, but the values are merely examples, and other values may be applied.

One or more embodiments (examples and modifications) described below can each be implemented independently. Meanwhile, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### 1. Introduction

As described above, for the purpose of expanding radio resources, utilization of a high frequency band called millimeter wave has been studied. Examples of the frequency band of the millimeter wave include frequency bands defined by frequency range 2 (FR2) and frequency range 3 (FR3). In addition, examples of the frequency band of the millimeter wave include frequency bands of 28 GHz (n257 and n261), 39 GHz (n260), and 40 GHz or more. In addition, examples of the frequency band higher than the millimeter wave include a terahertz wave which is a frequency band of 0.1 to 100 THz.

In a high frequency band of millimeter waves or more, the radio wave has strong rectilinearity, and it may be difficult for the terminal apparatus to obtain sufficient radio field intensity due to shielding by buildings, people, vehicles, and the like.

As described above, in the beam sweeping, the terminal apparatus selects a beam having a high radio field intensity from a plurality of beams and performs communication, whereby higher communication quality can be maintained.

However, since the radiation angle of the beam that can be formed by the terminal apparatus is determined, it may be difficult to obtain sufficient radio field intensity even by beam sweeping due to the influence of shielding objects depending on the surrounding environment of the terminal apparatus.

Even in such a case, for example, when the user moves or rotates the terminal apparatus, there is a possibility that the terminal apparatus can obtain sufficient radio field intensity. As described above, in order to move the terminal apparatus or the like in order to obtain sufficient radio field intensity, a means for confirming the radiation angle of the beam radiated from the terminal apparatus is required.

Conventionally, a technique for estimating an “arrival direction” of a beam arriving at a terminal apparatus from another wireless communication apparatus communicating with the terminal apparatus is known. However, a technique for confirming the “radiation angle” or the “radiation direction” of the beam radiated by the terminal apparatus to another wireless communication apparatus is not known.

Therefore, the terminal apparatus (an example of a communication apparatus) according to the technology of the present disclosure enables confirmation of the radiation angle of the beam radiated from the terminal apparatus, thereby further improving the quality of communication using the beam.

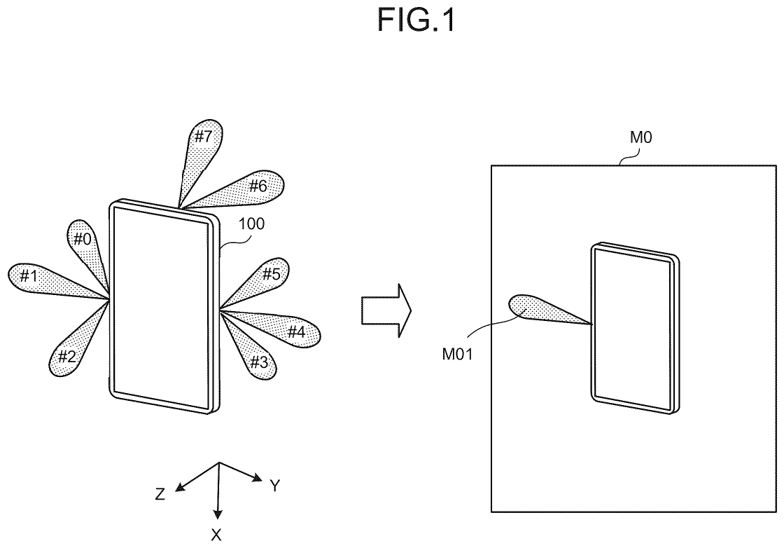

FIG. 1 is a diagram for explaining an example of a terminal apparatus 100 according to the technology of the present disclosure. Note that, hereinafter, XYZ coordinates are illustrated in the drawings. The Z-axis direction corresponds to the thickness direction of the terminal apparatus 100. The X-axis direction and the Y-axis direction correspond to a planar direction of the terminal apparatus 100.

In the following description, a surface on which a screen (display) is provided among external appearance surfaces constituting the terminal apparatus 100 may be referred to as a “front surface” for convenience, and a surface opposite to the front surface among external appearance surfaces constituting the terminal apparatus 100 may be referred to as a “back surface”.

As described above, the terminal apparatus 100 according to the technology of the present disclosure forms a beam and communicates with other wireless communication apparatuses. As illustrated in the left diagram of FIG. 1, identification information for identifying each beam is assigned to each beam used for communication by the terminal apparatus 100.

In the example of FIG. 1, three beams to which identification information “#0” to “#2” is assigned are emitted from an antenna module (not illustrated) arranged on a side surface of the terminal apparatus 100 in the negative direction of the Y axis. In addition, two beams to which identification information “#6” and “#7” is assigned are emitted from an antenna module (not illustrated) arranged on a side surface of the terminal apparatus 100 in the negative direction of the X axis.

Note that the beam illustrated in FIG. 1 is an example, and the beam formed by the terminal apparatus 100 is not limited thereto. For example, the terminal apparatus 100 may have a quantity of beams emitted from one antenna module of 1 or 4 or more. In addition, the number and arrangement of the antenna modules are not limited to the example of FIG. 1. For example, two or more antenna modules may be disposed on one side surface of the terminal apparatus 100. Furthermore, for example, the antenna module may be arranged on the back surface or the side surface in the positive direction of the X axis of the terminal apparatus 100.

In addition, the terminal apparatus 100 may emit a beam in each direction of a three-dimensional space. Specifically, for example, the terminal apparatus 100 may form a beam having a predetermined angle (Phi) in the XY plane and further having a predetermined angle (Theta) in the XZ plane.

The terminal apparatus 100 acquires identification information of a beam used for communication with another communication apparatus. As illustrated in the right diagram of FIG. 1, the terminal apparatus 100 displays radiation information regarding at least one of the radiation angle or the radiation direction of the beam corresponding to the acquired identification information on a screen (display).

In FIG. 1, for example, it is assumed that the terminal apparatus 100 is performing communication using a beam of identification information “#1”. In this case, the terminal apparatus 100 acquires the identification information “#1” used for communication, and displays an image MO on the display. The image MO includes a beam image M01. The beam image M01 is image information indicating the radiation angle or the radiation direction of the beam #1 identified by the identification information “#1”.

As described above, the terminal apparatus 100 according to the technology of the present disclosure displays the radiation information corresponding to the identification information of the beam used for communication with another communication apparatus on a display apparatus such as a display. As a result, the user can confirm the beam radiated from the terminal apparatus 100, and can move or rotate the terminal apparatus 100 according to the radiation angle and the radiation direction of the beam. Therefore, the terminal apparatus 100 can further improve the quality of communication using the beam.

### 2. Configuration Example of Terminal Apparatus

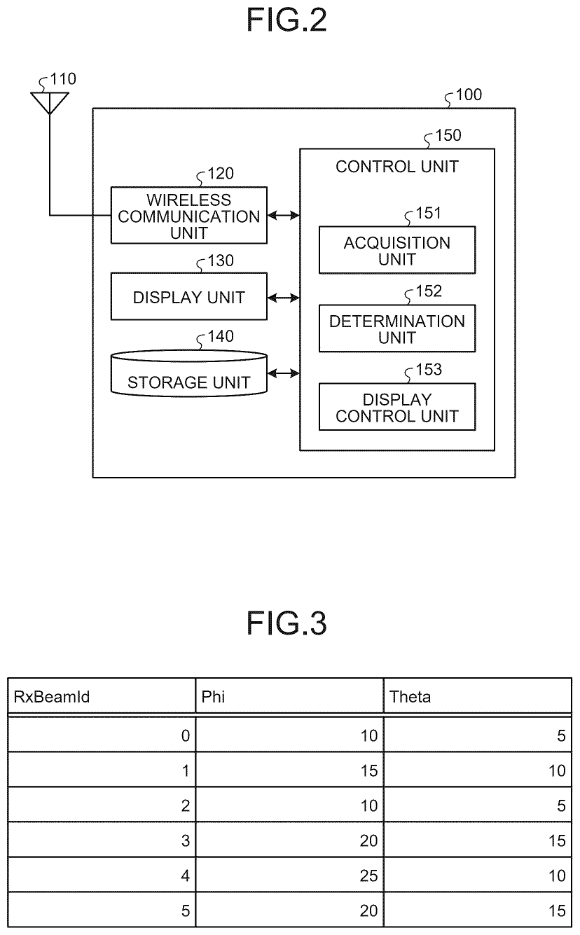

FIG. 2 is a block diagram illustrating an example of a schematic configuration of the terminal apparatus 100 according to the embodiment of the present disclosure. Referring to FIG. 2, the terminal apparatus 100 includes an antenna unit 110, a wireless communication unit 120, a display unit 130, a storage unit 140, and a control unit 150.

### (1) Antenna Unit 110

The antenna unit 110 radiates a signal output from the wireless communication unit 120 into space as a radio wave. Furthermore, the antenna unit 110 converts a radio wave in space into a signal and outputs the signal to the wireless communication unit 120. Note that the antenna unit 110 of the present embodiment can include one or more antenna modules (antenna apparatus, not illustrated). The antenna module includes a plurality of antenna elements (not illustrated), and can form one or more beams.

### (2) Wireless Communication Unit 120

The wireless communication unit 120 is a communication unit that transmits and receives signals. For example, the wireless communication unit 120 receives a signal from another wireless communication apparatus (for example, a base station or the like) and transmits the signal to the other wireless communication apparatus. Note that the wireless communication unit 120 of the present embodiment can communicate with another wireless communication apparatus by forming a plurality of beams by the antenna unit 110. In addition, the wireless communication unit 120 of the present embodiment notifies the control unit 150 of identification information (hereinafter, described as beam identification information) of a beam used for communication.

### (3) Display Unit 130

The display unit 130 is, for example, a touch panel type display. The display unit 130 is realized by, for example, a display apparatus such as a liquid crystal display (LCD) or an organic electroluminescence (EL) display. The display unit 130 displays various display screens under the control of the control unit 150.

### (4) Storage Unit 140

The storage unit 140 temporarily or permanently stores programs and various data for the operation of the terminal apparatus 100. The storage unit 140 of the present embodiment stores beam radiation information in which beam identification information is associated with radiation information regarding a radiation angle or a radiation direction of a beam.

FIG. 3 is a table illustrating an example of beam radiation information according to the embodiment of the present disclosure. In the example illustrated in FIG. 3, the storage unit 140 stores, as the beam radiation information, the beam identification information (RxBeem ID), and the angle (Phi) in the XY plane and the angle (Theta) in the XZ plane in association with each other. That is, here, a case where the radiation information is a three-dimensional radiation angle of the beam is illustrated.

Note that, although the case where the beam identification information is the RxBeem ID has been described here, the beam identification information is not limited thereto. The beam identification information may be beam identification information set for each terminal apparatus 100 as long as the wireless communication unit 120 can identify a beam to be used for communication.

In addition, the beam identification information can be assigned to each beam for each of the reception beam and the transmission beam. Alternatively, one piece of beam identification information may be assigned to both the reception beam and the transmission beam as the communication beam used for communication. For example, in a case where the wireless communication unit 120 performs transmission using the same beam as the reception beam, beam identification information (for example, RxBeem ID) for identifying the reception beam can be treated as information for identifying the beam used for communication.

In addition, here, the case where the radiation information is the radiation angle of the beam in the XYZ coordinates has been described, but the radiation information is not limited thereto. The radiation information only needs to be any information regarding the radiation angle or the radiation direction of the beam, and may be, for example, vector information indicating the radiation direction of the beam.

Furthermore, the storage unit 140 may store information other than the radiation angle and/or the radiation direction as the radiation information. For example, the storage unit 140 may store, as the radiation information, the radiation position of the beam, that is, the position of the antenna module forming the beam in the terminal apparatus 100.

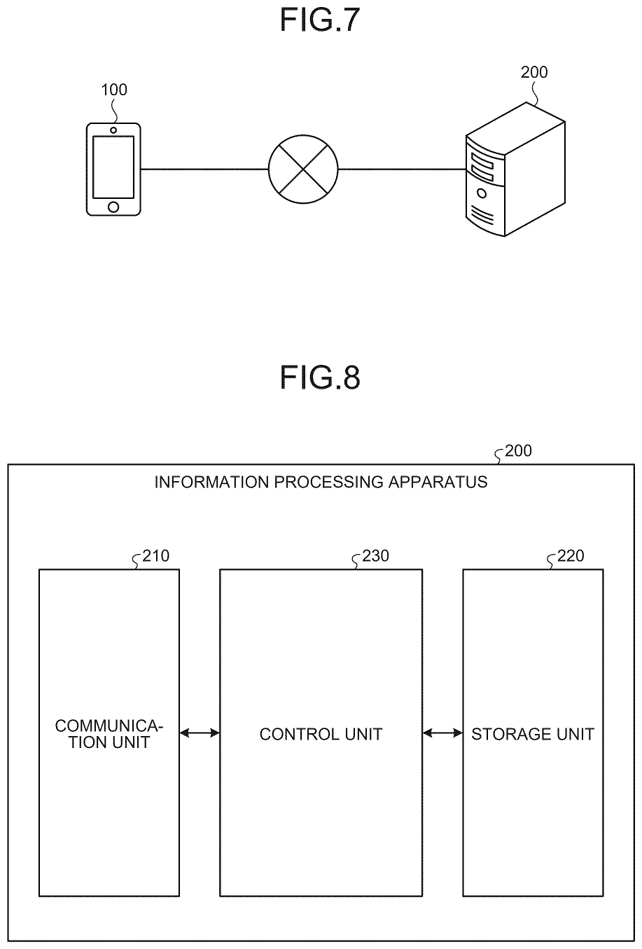

The storage unit 140 stores beam radiation information associated in advance. An example of a method for generating beam radiation information will be described later with reference to FIG. 7 and the like. The storage unit 140 may store the beam radiation information in advance at the time of shipment, or may acquire the beam radiation information from an external apparatus such as a base station.

### (5) Control Unit 150

Returning to FIG. 2, the control unit 150 is a controller that controls each unit of the terminal apparatus 100. The control unit 150 is realized by, for example, a processor such as a central processing unit (CPU), a micro processing unit (MPU), or a graphics processing unit (GPU). For example, the control unit 150 is realized by the processor executing various programs stored in a storage apparatus inside the terminal apparatus 100 using a random access memory (RAM) or the like as a work area. Note that the control unit 150 may be realized by an integrated circuit such as an application specific integrated circuit (ASIC) or a field programmable gate array (FPGA). Any of the CPU, the MPU, the GPU, the ASIC, and the FPGA can be regarded as a controller.

The control unit 150 includes an acquisition unit 151, a determination unit 152, and a display control unit 153. Each block (the acquisition unit 151 to the display control unit 153) constituting the control unit 150 is a functional block indicating a function of the control unit 150. These functional blocks may be software blocks or hardware blocks. For example, each of the functional blocks described above may be one software module realized by software (including microprograms), or may be one circuit block on a semiconductor chip (die). Of course, each functional block may be one processor or one integrated circuit. A configuration method of the functional block is arbitrary. Note that the control unit 150 may be configured by a functional unit different from the above-described functional block.

### (5-1) Acquisition Unit 151

For example, the acquisition unit 151 acquires the beam identification information from the wireless communication unit 120. The acquisition unit 151 outputs the acquired beam identification information to the determination unit 152.

### (5-2) Determination Unit 152

For example, the determination unit 152 determines the radiation information corresponding to the beam identification information on the basis of the beam radiation information stored in the storage unit 140. For example, the determination unit 152 can generate a display image on the basis of the determined radiation information.

### (5-3) Display Control Unit 153

The display control unit 153 displays the display image on the display unit 130. Note that the display control unit 153 may generate the display image on the basis of the radiation information determined by the determination unit 152.

Furthermore, the display control unit 153 can display a display image on a display apparatus other than the display unit 130. The display control unit 153 can display, for example, a display image on a display apparatus such as a glasses-type device such as AR glasses or a head-mounted-type device such as a VR head-mounted display. As described above, in a case where the display control unit 153 displays the display image on the display apparatus outside the terminal apparatus 100, the terminal apparatus 100 may not include the display unit 130.

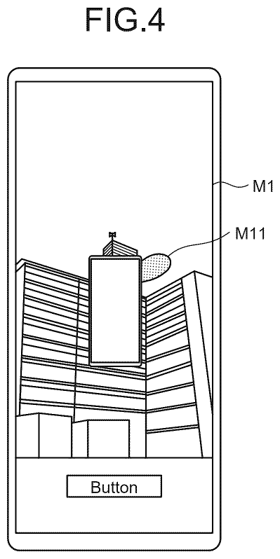

FIG. 4 is a diagram illustrating an example of a display image displayed by the display control unit 153 according to the embodiment of the present disclosure. FIG. 4 illustrates an example in which the display control unit 153 displays a display image M1 including the radiation information on the display unit 130.

The display image M1 includes a peripheral image of the terminal apparatus 100, an image of the terminal apparatus 100, and an image M11 indicating radiation information. The peripheral image of the terminal apparatus 100 is, for example, an image captured by a camera (not illustrated) mounted on the terminal apparatus 100.

As described above, the display control unit 153 displays the image M11 indicating the radiation information on the display unit 130, so that the user using the terminal apparatus 100 can confirm in which direction the beam is radiated from the terminal apparatus 100. At this time, the display control unit 153 displays the radiation information on the display unit 130 as a three-dimensional image, so that the user can three-dimensionally confirm in which direction the beam is radiated from the terminal apparatus 100.

In addition, the display image M1 includes a peripheral image of the terminal apparatus 100. As a result, the user can confirm in which direction the beam is emitted in the real space.

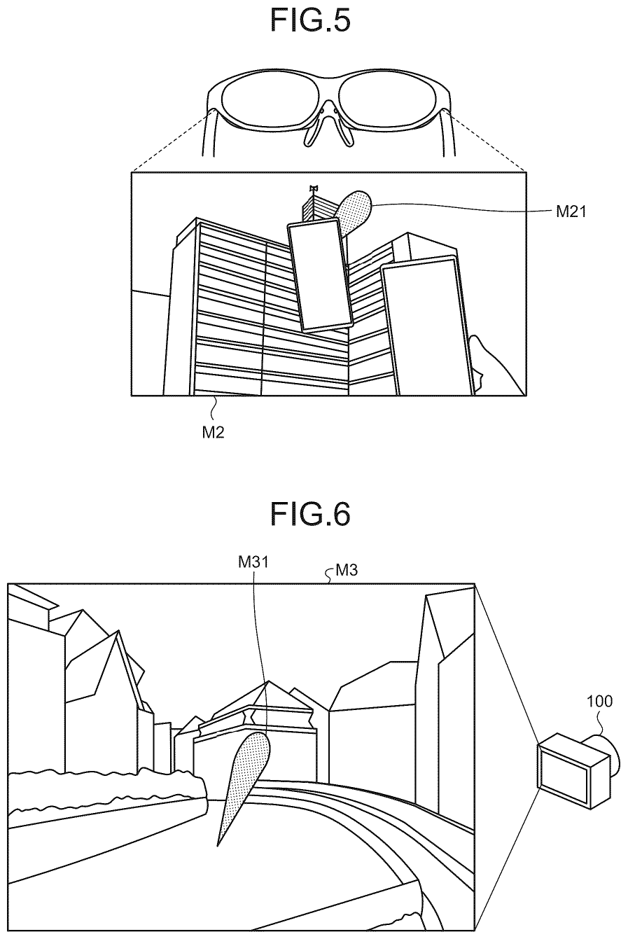

FIG. 5 is a diagram illustrating another example of the display image displayed by the display control unit 153 according to the embodiment of the present disclosure. In FIG. 5, the display control unit 153 displays a display image M2 on a display apparatus (here, AR glasses) other than the display unit 130. The display image M2 includes an image of the terminal apparatus 100 and an image M21 indicating radiation information.

In this manner, the display control unit 153 displays the image M21 indicating the radiation information on the display apparatus on the display unit 130, so that the user can confirm in which direction the beam is radiated from the terminal apparatus 100.

Note that, here, the display control unit 153 displays the display image M2 including the image of the terminal apparatus 100 and the image M21 indicating the radiation information on the display apparatus, but the display image displayed by the display control unit 153 is not limited thereto.

For example, in a case where the terminal apparatus 100 can detect its own apparatus (the terminal apparatus 100 itself) in the display area of the display apparatus, the display control unit 153 may superimpose the radiation information on the detected terminal apparatus 100 and display the radiation information on the display apparatus. In this case, the display control unit 153 displays an image M21 indicating the radiation information at a place of the display apparatus corresponding to the position of the terminal apparatus 100.

FIG. 6 is a diagram illustrating another example of the display image displayed by the display control unit 153 according to the embodiment of the present disclosure. In the above-described embodiment, the terminal apparatus 100 is an information processing terminal such as a smartphone, but the terminal apparatus 100 is not limited to an information processing terminal such as a smartphone. For example, the terminal apparatus 100 may be an imaging apparatus such as a camera.

In this case, the display control unit 153 displays a display image M3 on the display unit 130 such as a sub monitor of the terminal apparatus 100. The display image M3 includes, for example, an image captured by the terminal apparatus 100 and an image M31 indicating radiation information. Note that FIG. 6 illustrates a case where the image of the terminal apparatus 100 is not included in the display image M3, but the image of the terminal apparatus 100 may be included in the display image M3 similarly to FIG. 4.

As described above, the control unit 150 of the terminal apparatus 100 according to the embodiment of the present disclosure acquires the beam identification information for identifying the beam used for communication by the wireless communication unit 120. The control unit 150 displays radiation information regarding at least one of the radiation angle or the radiation direction of the beam corresponding to the beam identification information on the display unit 130.

As a result, the terminal apparatus 100 can provide more advanced information to the user who uses the terminal apparatus 100. The user can confirm in which direction the beam is emitted from the terminal apparatus 100, and can improve the communication quality of the terminal apparatus 100 by moving the terminal apparatus 100 or the like.

Note that, in a case where the wireless communication unit 120 switches the beam to be used for communication, the terminal apparatus 100 can switch and present the radiation information to the user. Specifically, the acquisition unit 151 acquires the beam identification information after switching by the wireless communication unit 120. The determination unit 152 determines radiation information corresponding to the beam identification information acquired by the acquisition unit 151. The display control unit 153 displays the radiation information determined by the determination unit 152 on the display unit 130.

As a result, even in a case where the beam used for communication by the wireless communication unit 120 is switched, the terminal apparatus 100 can present the radiation information regarding the beam after the switching to the user.

### 3. Beam Radiation Information

Next, a method for generating beam radiation information will be described. The beam radiation information according to the embodiment of the present disclosure is generated by an information processing system 1, for example.

FIG. 7 is a diagram illustrating a configuration example of the information processing system 1 according to the embodiment of the present disclosure. As illustrated in FIG. 7, the information processing system 1 includes a terminal apparatus 100 and an information processing apparatus 200.

The terminal apparatus 100 is the same as the terminal apparatus 100 illustrated in FIG. 2. Alternatively, the terminal apparatus 100 only needs to have the same configuration in the antenna unit 110 as the terminal apparatus 100 illustrated in FIG. 2, that is, form the same beam, and other configurations may be different from those of the terminal apparatus 100 illustrated in FIG. 2.

The information processing apparatus 200 generates, for example, beam radiation information. For example, the information processing apparatus 200 acquires information regarding the beam from the terminal apparatus 100 connected via the network, and estimates the radiation angle of the beam. The information processing apparatus 200 generates beam radiation information by associating the beam identification information with the estimated beam radiation angle.

Here, FIG. 8 is a block diagram illustrating a configuration example of the information processing apparatus 200 according to the embodiment of the present disclosure. The information processing apparatus 200 includes a communication unit 210, a storage unit 220, and a control unit 230. Note that the configuration illustrated in FIG. 8 is a functional configuration, and the hardware configuration may be different from the functional configuration. Furthermore, the functions of the information processing apparatus 200 may be implemented in a distributed manner in a plurality of physically separated configurations. For example, the information processing apparatus 200 may include a plurality of server apparatuses.

The communication unit 210 is a communication interface for communicating with other apparatuses. The communication unit 210 may be a network interface or a device connection interface. For example, the communication unit 210 may be a local area network (LAN) interface such as a network interface card (NIC), or may be a USB interface including a universal serial bus (USB) host controller, a USB port, and the like. Furthermore, the communication unit 210 may be a wired interface or a wireless interface. The communication unit 210 functions as a communication means of the information processing apparatus 200.

The storage unit 220 is a data readable/writable storage apparatus such as a dynamic random access memory (DRAM), a static random access memory (SRAM), a flash memory, or a hard disk. The storage unit 220 functions as a storage means of the information processing apparatus 200.

The control unit 230 is a controller that controls each unit of the information processing apparatus 200. The control unit 230 is realized by, for example, a processor such as a CPU or an MPU. For example, the control unit 230 is implemented by a processor executing various programs stored in a storage apparatus inside the information processing apparatus 200 using a RAM or the like as a work area. Note that the control unit 230 may be realized by an integrated circuit such as an ASIC or an FPGA. Any of the CPU, the MPU, the ASIC, and the FPGA can be regarded as a controller.

As described above, the information processing apparatus 200 generates the beam radiation information. Hereinafter, first to fourth generation methods will be described as examples of a generation method by which the information processing apparatus 200 generates beam radiation information.

### <3.1. First Generation Method>

The information processing apparatus 200 estimates radiation information (for example, the radiation angle) of a beam radiated from an antenna module 110A of the terminal apparatus 100 and generates beam radiation information.

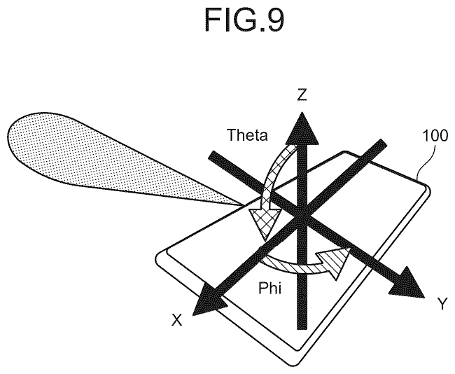

FIG. 9 is a diagram for explaining an example of the radiation angle estimated by the information processing apparatus 200 according to the embodiment of the present disclosure. As illustrated in FIG. 9, the information processing apparatus 200 estimates an angle Phi in the XY plane and an angle Theta in the XZ plane as the radiation angle of the beam.

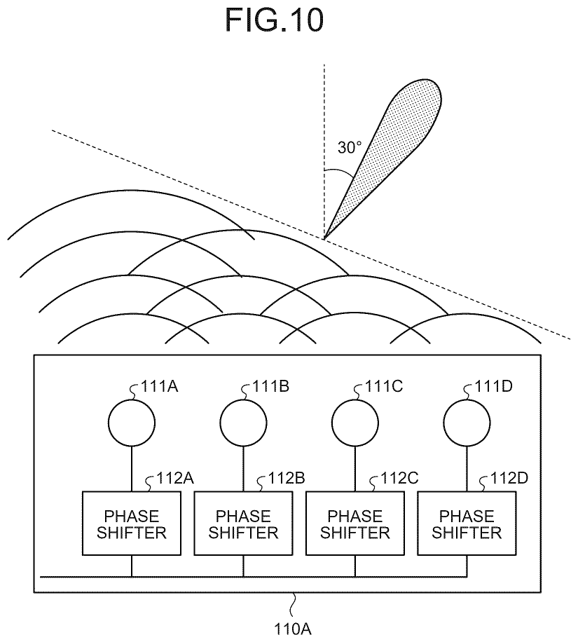

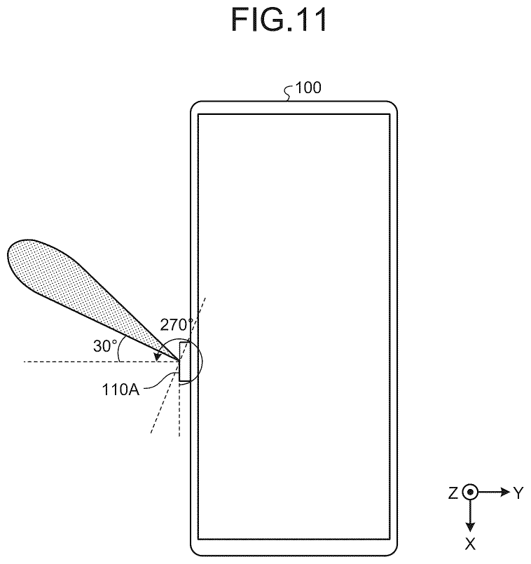

FIGS. 10 and 11 are diagrams for explaining an example of estimation of the radiation angle by the information processing apparatus 200 according to the embodiment of the present disclosure.

FIG. 10 illustrates an example of a beam radiated by the antenna module 110A. The antenna module 110A is included in, for example, the antenna unit 110 (see FIG. 2) of the terminal apparatus 100.

FIG. 11 illustrates the terminal apparatus 100 on which the antenna module 110A illustrated in FIG. 10 is mounted. FIG. 11 illustrates an example of a case where the antenna module 110A is mounted on a side surface of the terminal apparatus 100 in the negative direction of the Y axis.

As illustrated in FIG. 10, the antenna module 110A includes a plurality of antenna elements 111A to 111D and phase shifters 112A to 112D arranged to correspond to the antenna elements 111A to 111D, respectively.

The antenna element 111 transmits or receives a signal. The phase shifter 112 controls a phase of a signal transmitted from the antenna element 111 or a signal received by the antenna element 111.

The antenna module 110A emits a beam having a predetermined radiation angle by adjusting the phase shift amount controlled by the phase shifter 112.

The information processing apparatus 200 acquires, from the terminal apparatus 100, beam identification information when the terminal apparatus 100 forms a predetermined beam and phase shift information related to the phase shifter 112. Examples of the information regarding the phase shifter 112 include a phase shift amount adjusted by the phase shifter 112.

The information processing apparatus 200 estimates the radiation angle of the beam with respect to the antenna module 110A from the phase shift information. In the example of FIG. 10, the information processing apparatus 200 estimates that the radiation angle of the beam on the plane of the antenna module 110A (the plane parallel to the antenna element 111) is 30 degrees.

Next, as illustrated in FIG. 11, the information processing apparatus 200 estimates the radiation angle of the beam in the terminal apparatus 100 from the mounting position (installation position) and the mounting angle (installation angle) of the antenna module 110A in the terminal apparatus 100 and the radiation angle of the beam in the antenna module 110A.

In the example of FIG. 11, the antenna module 110A is mounted on the side surface of the terminal apparatus 100 in the negative direction of the Y axis. The information processing apparatus 200 estimates the angle Phi in the XY plane of the beam corresponding to the beam identification information acquired from the terminal apparatus 100 as 270 degrees−30 degrees=240 degrees.

Note that, here, an example of a case has been described in which the information processing apparatus 200 estimates the angle Phi as the radiation angle of the beam, but the information processing apparatus 200 similarly estimates the angle Theta.

For example, the information processing apparatus 200 acquires beam identification information for beams that can be formed by all the antenna modules 110A mounted on the terminal apparatus 100, and estimates the radiation angles of the beams.

The information processing apparatus 200 generates beam radiation information (see FIG. 3) by associating the estimated radiation angle of the beam with the beam identification information.

Note that the information processing apparatus 200 can acquire information of the phase shifter 112 (for example, the phase shift amount of each phase shifter 112) in a state where the antenna module 110A of the terminal apparatus 100 actually forms a beam.

Alternatively, for example, in a case where the phase shift amount set in the phase shifter 112 is determined in advance for each beam, the information processing apparatus 200 can acquire phase shift setting information in which the beam (for example, the beam identification information) and the phase shift amount of each phase shifter 112 are associated with each other as information of the phase shifter 112.

As described above, the information processing apparatus 200 acquires the phase shift setting information regarding the preset phase shift amount, whereby the terminal apparatus 100 does not need to actually form a beam when the information processing apparatus 200 estimates the radiation angle.

Note that the information processing apparatus 200 may acquire the phase shift setting information from the terminal apparatus 100 or may acquire the phase shift setting information from another apparatus. Alternatively, the information processing apparatus 200 may directly receive the phase shift setting information from, for example, a system designer or the like.

### <3.2. Second Generation Method>

In the first generation method, the information processing apparatus 200 estimates the radiation angle of the beam from the information of the phase shifter 112 of the antenna module 110A, but the method of estimating the radiation angle by the information processing apparatus 200 is not limited thereto.

For example, the information processing apparatus 200 may estimate the radiation angle on the basis of the radiation power (EIRP: Equivalent Isotropically Radiated Power) of the radio wave radiated by the antenna module 110A. A method of estimating the radiation angle on the basis of the EIRP and generating the beam radiation information as described above is defined as a second generation method.

For example, the information processing apparatus 200 receives a beam radiated by the terminal apparatus 100 using a measurement antenna (not illustrated) and measures the EIRP. The information processing apparatus 200 measures the EIRP while changing the relative position (angles Theta and Phi, see FIG. 9) between the terminal apparatus 100 and the measurement antenna in a state where the beam radiated by the terminal apparatus 100 is fixed. As a result, the information processing apparatus 200 measures the EIRP around the terminal apparatus 100 when the predetermined beam is used.

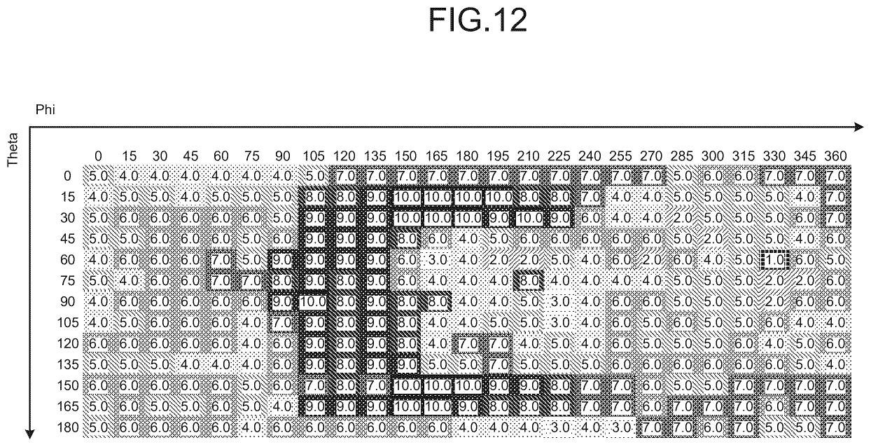

FIG. 12 is a diagram illustrating an example of an EIRP acquired by the information processing apparatus 200 according to the embodiment of the present disclosure. FIG. 12 illustrates an example of the EIRP in a case where the relative angles (Phi and Theta) between the terminal apparatus 100 and the measurement antenna are changed by 15 degrees.

For example, the information processing apparatus 200 measures the EIRP around the terminal apparatus 100 by executing the following measurement processing.
(step1) The angle Theta is fixed to 0 degrees.
(step2) The EIRP is measured while the angle Phi is rotated by 15 degrees from 0 degrees to 360 degrees.
(step3) In a case where the angle Theta reaches 180 degrees, the measurement processing is terminated, and otherwise, step4 is executed.
(step4) The angle Theta is rotated by 15 degrees, and the process returns to step2.

Note that the angles Theta and Phi may be rotated by rotating the terminal apparatus 100, or the angles Theta and Phi may be rotated by moving the measurement antenna.

As a result of executing the measurement processing, the information processing apparatus 200 estimates a combination of angles Phi and Theta with the highest EIRP as the radiation angle. The information processing apparatus 200 executes measurement processing for each beam to estimate the radiation angle. The information processing apparatus 200 generates beam radiation information by combining the estimated radiation angle and the beam identification information.

Here, the information processing apparatus 200 executes the measurement processing, but the apparatus that executes the measurement processing is not limited to the information processing apparatus 200. An apparatus (for example, a measurement apparatus) different from the information processing apparatus 200 may execute the measurement processing to measure the EIRP. In this case, the information processing apparatus 200 acquires information regarding the EIRP from a measurement apparatus (not illustrated).

Furthermore, here, the information processing apparatus 200 measures the EIRP at intervals of 15 degrees, but the present invention is not limited thereto. The angle by which the terminal apparatus 100 (or the measurement antenna) is rotated may be greater than 15 degrees or less than 15 degrees. In addition, the angle to be rotated may be different between the angle Theta and the angle Phi.

In this manner, the information processing apparatus 200 estimates the radiation angle of the beam by experiment or the like and generates the beam radiation information.

### <3.3. Third Generation Method>

In the second generation method, the information processing apparatus 200 estimates the radiation angle on the basis of the angles Theta and Phi with the largest EIRP, but the method of estimating the radiation angle is not limited thereto. For example, the information processing apparatus 200 may estimate the radiation angle on the basis of the distribution of the EIRP. Such a method will be described as a third generation method.

The information processing apparatus 200 executes measurement processing similarly to the second generation method, measures EIRP at each of the angles Theta and Phi, and generates a distribution table of EIRPs corresponding to one beam (see FIG. 12).

The information processing apparatus 200 estimates the radiation angle of the beam by using an algorithm such as kernel density estimation for a part or the whole of the generated distribution table of EIRPs.

The kernel density estimation is a method of calculating a point density within an arbitrarily designated search radius around a point where the density is calculated, with weighting by a distance attenuation effect from a total of three points.

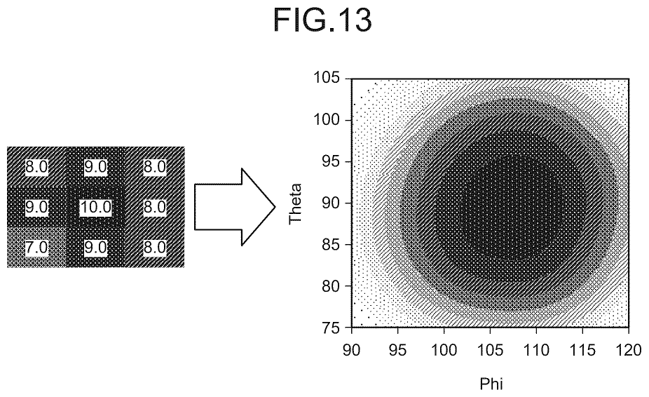

FIG. 13 is a diagram for explaining an example of the third generation method according to the embodiment of the present disclosure. The information processing apparatus 200 uses, as a reference point, a combination of angles at which the EIRP is the highest in the distribution table of the EIRPs, and estimates the radiation angle in consideration of the EIRPs of the surrounding cells.

For example, as illustrated in the left diagram of FIG. 13, the information processing apparatus 200 executes two-dimensional kernel density estimation on the basis of information of 3*3 surrounding cells from a position with the highest EIRP in the distribution table of EIRPs. For example, the information processing apparatus 200 acquires the kernel density estimation result illustrated in the right diagram of FIG. 13. The information processing apparatus 200 estimates the center of the darkest circle in the right diagram of FIG. 13 as the radiation angle of the beam.

For example, the information processing apparatus 200 performs measurement of the EIRP and estimation of the radiation angle using the measurement result for all beams that can be formed by the terminal apparatus 100, and generates beam radiation information.

In this manner, the information processing apparatus 200 can estimate the radiation angle of the beam using the distribution of the EIRP, thereby estimating the radiation angle at a granularity finer than the granularity (for example, 15 degrees in the example of FIG. 12) of the EIRP measurement.

### <3.4. Fourth Generation Method>

In the first to third generation methods described above, the information processing apparatus 200 acquires the information (phase shift information or EIRP) of the terminal apparatus 100 and generates the beam radiation information, but the information used when the information processing apparatus 200 generates the beam radiation information is not limited thereto.

For example, the information processing apparatus 200 may generate the beam radiation information by using information regarding a base station (an example of another communication apparatus) that communicates with the terminal apparatus 100. Such a generation method will be described as a fourth generation method.

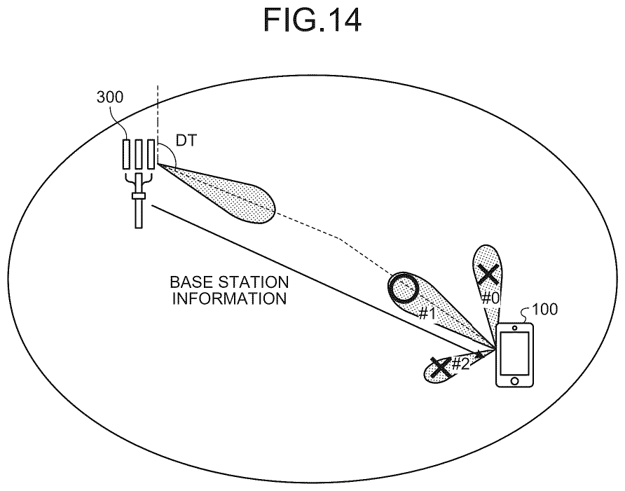

FIG. 14 is a diagram for explaining an example of the fourth generation method according to the embodiment of the present disclosure. As illustrated in FIG. 14, it is assumed that the terminal apparatus 100 communicates with a base station 300 using a beam.

In the communication using the millimeter wave, the beam from the base station 300 and the beam of the terminal apparatus 100 cross each other, so that the terminal apparatus 100 communicates with the base station 300. In addition, as described above, the radio wave has high rectilinearity in a high frequency band of millimeter waves or more.

By using the rectilinearity of the millimeter wave, the information processing apparatus 200 can estimate the coordinates (radiation angle) of the beam of the terminal apparatus 100 from the coordinates (radiation angle) of the beam radiated by the base station 300.

Specifically, the base station 300 notifies the terminal apparatus 100 of information regarding a beam used for communication with the terminal apparatus 100 as, for example, base station information. The base station information may include, for example, position information (latitude information, longitude information, altitude information, and the like) of the base station 300 and beam radiation azimuth/downtilt angle (see DT in FIG. 14) information.

The terminal apparatus 100 notifies the information processing apparatus 200 of the acquired base station information and terminal information regarding itself. The terminal information can include, for example, position information (latitude information, longitude information, altitude information, and the like) of the terminal apparatus 100. Note that the base station information may be notified from the base station 300 to the information processing apparatus 200 without passing through the terminal apparatus 100.

In addition, the terminal apparatus 100 notifies the information processing apparatus 200 of beam identification information for identifying a beam used for communication. For example, in the example of FIG. 14, the terminal apparatus 100 communicates with the base station 300 using the beam #1 instead of the beams #0 and #2.

The information processing apparatus 200 estimates the radiation angle of the beam (beam #1 in FIG. 14) using the base station information and the terminal information. The information processing apparatus 200 estimates radiation angles for all beams used by the terminal apparatus 100 for communication, and generates beam radiation information.

Note that the first to fourth generation methods described above are executed by the information processing apparatus 200, but the apparatus that executes the generation method is not limited to the information processing apparatus 200. For example, the terminal apparatus 100 may execute the first to fourth generation methods. That is, the terminal apparatus 100 can also operate as the information processing apparatus 200.

Furthermore, as described above, the first to fourth generation methods can be executed in advance, for example, before shipment of a product or the like. However, the fourth generation method may be executed when the terminal apparatus 100 actually communicates with the base station 300 after shipment. Alternatively, the beam radiation information generated before shipment may be updated using the fourth generation method when the terminal apparatus 100 actually communicates with the base station 300 after shipment.

### 4. Information Processing

### <4.1. Generation Processing>

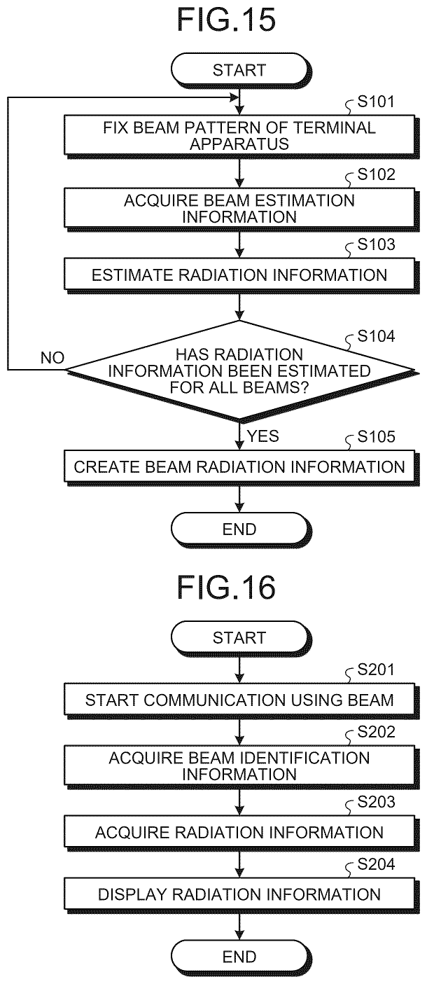

FIG. 15 is a flowchart illustrating an example of a flow of generation processing according to the embodiment of the present disclosure. The generation processing is pre-processing performed by the information processing apparatus 200, for example, before display processing to be described later.

As illustrated in FIG. 15, the information processing apparatus 200 first fixes the beam pattern of the terminal apparatus 100 (step S101). Alternatively, the information processing apparatus 200 may acquire identification information of a beam emitted by the terminal apparatus 100.

The information processing apparatus 200 acquires the beam estimation information from the terminal apparatus 100 (step S102). In a case where the information processing apparatus 200 executes the first generation method, the beam estimation information is, for example, phase shift information of the terminal apparatus 100. In a case where the information processing apparatus 200 executes the second or third generation method, the beam estimation information is, for example, the EIRP of the terminal apparatus 100. In a case where the information processing apparatus 200 executes the fourth generation method, the beam estimation information is the base station information and the terminal information described above.

The information processing apparatus 200 estimates beam radiation information by using the acquired beam estimation information (step S103). The information processing apparatus 200 determines whether or not radiation information has been estimated for all beams that can be formed by the terminal apparatus 100 (step S104).

In a case where there is a beam for which radiation information has not been estimated (step S104; No), the information processing apparatus 200 returns to step S101 and acquires information regarding the beam that has not been estimated from the terminal apparatus 100.

Meanwhile, in a case where the radiation information has been estimated for all the beams (step S104; Yes), the information processing apparatus 200 generates beam radiation information (step S105), and ends the processing.

### <4.2. Display Processing>

FIG. 16 is a flowchart illustrating an example of a flow of display processing according to the embodiment of the present disclosure. The display processing is executed by the terminal apparatus 100 in a case where the user uses the terminal apparatus 100 after product shipment, for example.

As illustrated in FIG. 16, the wireless communication unit 120 of the terminal apparatus 100 starts communication using a beam (step S201). The control unit 150 of the terminal apparatus 100 acquires the beam identification information of the beam used for communication from the wireless communication unit 120 (step S202).

The control unit 150 refers to, for example, the beam radiation information stored in the storage unit 140 and acquires radiation information corresponding to the beam identification information (step S203). As described above, the beam radiation information is information in which the beam identification information is associated with the radiation information including at least one of the radiation angle or the radiation direction of the beam in advance.

The control unit 150 displays the acquired radiation information on the display unit 130 (step S204). For example, the control unit 150 displays an image of the terminal apparatus 100 and an image (for example, a three-dimensional image) indicating the radiation angle of the beam on the display unit 130.

### 5. Application Example

In the above-described embodiment, the terminal apparatus 100 presents the radiation information of its own antenna to the user, but the information presented by the terminal apparatus 100 to the user is not limited to the radiation information. For example, the terminal apparatus 100 may provide quality information regarding a direction in which communication quality is good to the user in addition to the radiation information.

Here, the quality information regarding the direction in which the communication quality is good is, for example, information indicating the radio field intensity of the millimeter wave for each point on the map and the direction in which the connection to the millimeter wave is easy at the point. That is, the quality information can also be said to be environment information regarding the radio wave environment of another wireless communication apparatus that communicates with the terminal apparatus 100. For example, the terminal apparatus 100 acquires the quality information from a generation apparatus (not illustrated) via, for example, a network or the like.

The generation apparatus is, for example, a cloud server apparatus disposed on a network. For example, the generation apparatus generates the quality information by performing statistical processing on the information collected from a plurality of terminal apparatuses 100.

For example, the generation apparatus collects, from the terminal apparatus 100, connection information including time information at the time of millimeter wave connection, position information, radio field intensity information, information in a terminal direction when the radio field intensity is observed, and the like. For example, the generation apparatus adds weighting information to data in consideration of a characteristic of a millimeter wave susceptible to a change in the surrounding environment so as to emphasize new connection information.

For example, on the basis of the collected connection information and weighting information, the generation apparatus generates quality information including radio field intensity information of the millimeter wave for each point on the map and direction information that facilitates connection to the millimeter wave at the position. The generation apparatus can generate, for example, quality information in a map format.

When acquiring the quality information from the generating apparatus, the terminal apparatus 100 displays the radiation information and the quality information of the antenna on the display unit 130 to present these pieces of information to the user.

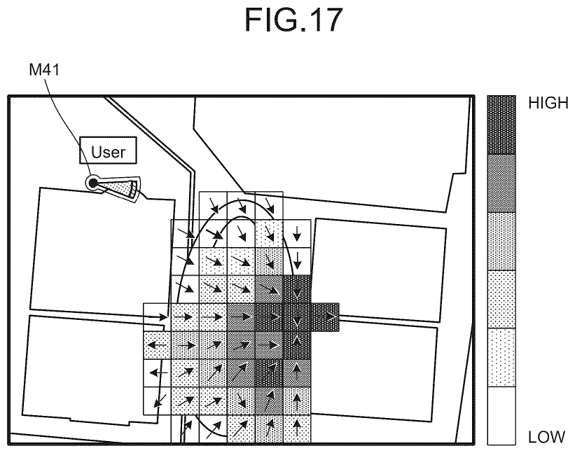

FIG. 17 is a diagram illustrating an example of an image displayed on the display unit 130 by the terminal apparatus 100 according to the application example of the embodiment of the present disclosure.

For example, as illustrated in FIG. 17, it is assumed that the generation apparatus divides the map into a plurality of cells in a lattice shape and generates quality information for each of the divided cells. In this case, the terminal apparatus 100 superimposes the quality information acquired from the generation apparatus on the map and presents the quality information to the user. Note that, in FIG. 17, the radio field intensity is indicated by the density of hatching, and it is indicated that the higher the hatching, the higher the radio field intensity. In addition, in FIG. 17, arrows in the cells indicates directions in each cell in which the connection to the millimeter wave is easy.

In addition to the quality information, the terminal apparatus 100 displays an image M41 indicating the position of the own apparatus on the map and the radiation information of the beam used for communication on the display unit 130.

As a result, the user can confirm the point where the radio field intensity of the millimeter wave is high and the direction in which the connection to the millimeter wave is easy at the point and the direction of the beam of the own terminal, and can direct the beam of the own terminal in the direction in which the connection is easy at the position where the connection to the millimeter wave is easy. This allows the user to further improve the quality of communication using the beam.

FIG. 17 illustrates an example in which the terminal apparatus 100 superimposes the quality information and the radiation information on the map to present, but the terminal apparatus 100 may superimpose the quality information and the radiation information on the peripheral image to present to the user.

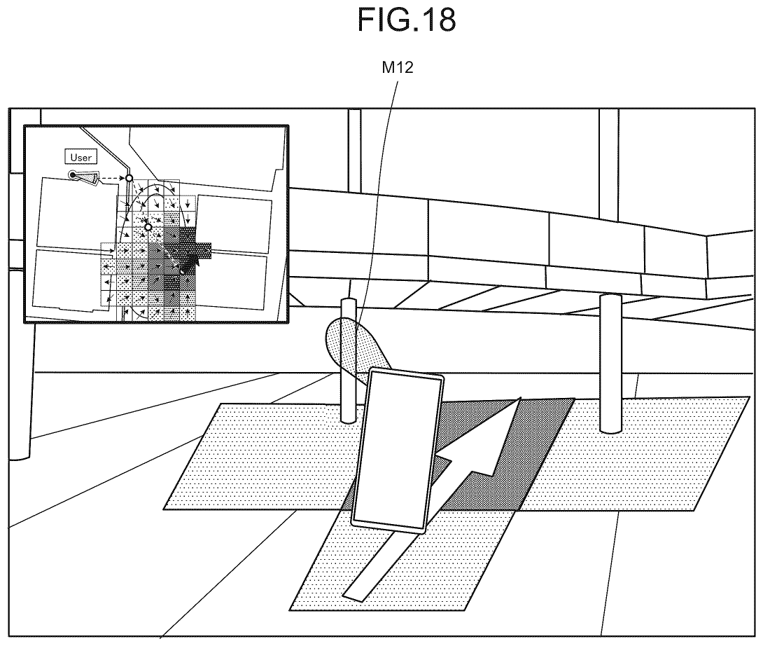

FIG. 18 is a diagram illustrating another example of an image displayed on the display unit 130 by the terminal apparatus 100 according to the application example of the embodiment of the present disclosure.

In FIG. 18, the terminal apparatus 100 calculates a route for guiding the user toward a point with high radio field intensity on the basis of the map information and the quality information, and superimposes route information regarding the route on the peripheral image to display on the display unit 130. At this time, for example, the terminal apparatus 100 superimposes an image M12 indicating beam radiation information on the route information and the peripheral image and displays the superimposed image on the display unit 130.

Note that although FIG. 18 illustrates a case where the terminal apparatus 100 displays the route information on the display unit 130, the terminal apparatus 100 may display the quality information on the display unit 130 by superimposing the quality information on the peripheral image.

Furthermore, the terminal apparatus 100 can present an image in which the quality information and the radiation information are superimposed on the three-dimensional space to the user.

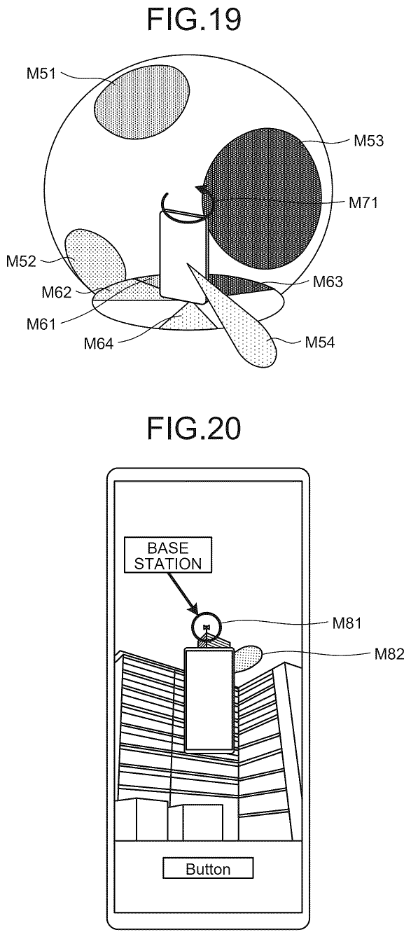

FIG. 19 is a diagram illustrating another example of an image displayed on the display unit 130 by the terminal apparatus 100 according to the application example of the embodiment of the present disclosure.

As illustrated in FIG. 19, the terminal apparatus 100 presents a direction in which the radio field intensity of the millimeter wave is strong to the user in the three-dimensional space by illustrating images M51 to M53 on a sphere. In addition, the terminal apparatus 100 presents a direction in which the radio field intensity of the millimeter wave is strong to the user by indicating images M61 to M63 in a circle indicating the ground.

In addition, the terminal apparatus 100 presents the radiation angle of the beam to the user by illustrating an image M54 illustrating the beam of the millimeter wave in the three-dimensional space. Furthermore, the terminal apparatus 100 presents the beam radiation information to the user by indicating an image M64 in a circle indicating the ground.

Furthermore, the terminal apparatus 100 may present, to the user, an image M71 including improvement information that urges movement (or rotation) of the own apparatus so as to improve communication quality. In FIG. 19, the terminal apparatus 100 presents an arrow that proposes rotation of the own apparatus to the user as an image M71.

The terminal apparatus 100 generates the improvement information on the basis of, for example, the quality information and the radiation information. For example, the terminal apparatus 100 generates the improvement information such that the radiation direction of the beam approaches the direction in which the connection to the millimeter wave is easy. The terminal apparatus 100 can generate the improvement information using, for example, machine learning or the like.

Note that the terminal apparatus 100 may present the image illustrated in FIG. 19 to the user by superimposing the image on, for example, a real space (peripheral image).

Furthermore, in a case where the position of another wireless communication apparatus that is a communication partner can be estimated, the terminal apparatus 100 may present position information regarding the position of the other wireless communication apparatus to the user in addition to the radiation information.

FIG. 20 is a diagram illustrating another example of an image displayed on the display unit 130 by the terminal apparatus 100 according to the application example of the embodiment of the present disclosure. Note that FIG. 20 illustrates a case where another wireless communication apparatus that is a communication partner of the terminal apparatus 100 is a base station of a millimeter wave.

For example, the terminal apparatus 100 estimates the position of the base station on the basis of the quality information and the transmission power information of the base station. The base station notifies the terminal apparatus 100 of the transmission power information of the base station, for example.

As illustrated in FIG. 20, for example, the terminal apparatus 100 superimposes an image M81 indicating the position of the base station on the peripheral image and presents the superimposed image to the user. In addition, the terminal apparatus 100 superimposes an image M82 indicating beam radiation information on the peripheral image and presents the superimposed image to the user.

As a result, the user can change the position and posture of the terminal apparatus 100 so as to further improve the communication quality while confirming the position of the base station and the radiation angle of the beam.

Note that FIG. 20 illustrates a case where the terminal apparatus 100 superimposes the position information of the base station and the radiation information of the beam of the terminal apparatus 100 on the peripheral image. However, the terminal apparatus 100 may superimpose these pieces of information on a map or the like, for example, and present these pieces of information to the user. For example, the terminal apparatus 100 may superimpose the position information of the base station on the image illustrated in FIG. 17.

### 6. Other Embodiments

The above-described embodiments are examples, and various modifications and applications are possible.

For example, the control apparatus that controls the terminal apparatus 100 and the information processing apparatus 200 of the above-described embodiments may be realized by a dedicated computer system or may be realized by a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure the control apparatus. At this time, the control apparatus may be an apparatus (for example, a personal computer) outside the terminal apparatus 100 and the information processing apparatus 200. Furthermore, the control apparatus may be an apparatus (for example, the control units 150 and 230) inside the terminal apparatus 100 and the information processing apparatus 200.

In addition, the above-described communication program may be stored in a disk apparatus included in a server apparatus on a network such as the Internet so that the communication program can be downloaded to a computer. In addition, the above-described functions may be realized by cooperation of an operating system (OS) and application software. In this case, a portion other than the OS may be stored in a medium and distributed, or a portion other than the OS may be stored in a server apparatus and downloaded to a computer or the like.

In addition, among the processes described in the above embodiments, all or a part of the processes described as being performed automatically can be performed manually, or all or a part of the processes described as being performed manually can be performed automatically by a known method. In addition, the processing procedures, specific names, and information including various data and parameters illustrated in the above-described document and the drawings can be arbitrarily changed unless otherwise specified. For example, the various types of information illustrated in each figure are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part thereof can be functionally or physically distributed and integrated in an arbitrary unit according to various loads, usage conditions, and the like. Note that this configuration by distribution and integration may be performed dynamically.

In addition, the above-described embodiments can be appropriately combined in an area in which the processing contents do not contradict each other. Furthermore, the order of each step illustrated in the flowchart of the above-described embodiments can be appropriately changed.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set obtained by further adding other functions to a unit, or the like (that is, a configuration of a part of the apparatus).

Note that, in the present embodiment, the system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Furthermore, for example, the present embodiment can adopt a configuration of cloud computing in which one function is shared and processed by a plurality of apparatuses in cooperation via a network.

### 7. Conclusion

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined. That is, at least a part of the one or more embodiments described above may be executed in combination with at least another part of the one or more embodiments described above.

Furthermore, the effects of each embodiment described in the present specification are merely examples and are not limited, and other effects may be provided.

Note that the present technology can also have the following configurations.
(1)

A communication apparatus comprising:
a communication unit that forms a beam and performs communication with another communication apparatus; and
a control unit that acquires identification information of the beam used for the communication with the another communication apparatus, and
displays radiation information regarding at least one of a radiation angle or a radiation direction of the beam corresponding to the identification information on a display apparatus.
(2)

The communication apparatus according to (1), wherein in a case where the communication unit switches the beam to be used for the communication, the control unit acquires the identification information of the beam after switching by the communication unit, and switches to the radiation information corresponding to the identification information acquired and displays the radiation information on the display apparatus.
(3)

The communication apparatus according to (1) or (2), wherein the control unit displays an image indicating the radiation information on the display apparatus.
(4)

The communication apparatus according to (3), wherein the control unit displays the image being three-dimensional indicating the radiation information on the display apparatus.
(5)

The communication apparatus according to (3) or (4), wherein the control unit superimposes the image on a peripheral image and displays the image superimposed on the display apparatus.
(6)

The communication apparatus according to any one of (1) to (5), wherein the control unit displays the radiation information and environment information regarding a radio wave environment of the another communication apparatus on the display apparatus.
(7)

The communication apparatus according to any one of (1) to (6), wherein the identification information is an RxBeem ID.
(8)

The communication apparatus according to any one of (1) to (7), wherein the control unit displays the radiation information associated with the identification information of the beam in advance on the display apparatus.
(9)

The communication apparatus according to any one of (1) to (8), wherein the radiation information is associated with the identification information of the beam on a basis of a radiation angle of an antenna apparatus used by the communication unit to form the beam and at least one of an installation position or an angle of the antenna apparatus.
(10)

The communication apparatus according to (9), wherein the radiation angle of the antenna apparatus is estimated on a basis of phase shift amounts of a plurality of phase shifters included in the antenna apparatus.
(11)

The communication apparatus according to any one of (1) to (8), wherein the radiation information is estimated by the communication unit measuring radiation power of an antenna apparatus used to form the beam.
(12)

The communication apparatus according to any one of (1) to (8), wherein the radiation information is estimated on a basis of position information of the another communication apparatus, a radiation angle of a beam radiated by the another communication apparatus, and position information of the communication apparatus itself.
(13)

A communication method comprising:
forming a beam and performing communication with another communication apparatus;
acquiring identification information of the beam used for the communication with the another communication apparatus; and
displaying radiation information regarding at least one of a radiation angle or a radiation direction of the beam corresponding to the identification information on a display apparatus.

### REFERENCE SIGNS LIST

1 INFORMATION PROCESSING SYSTEM
300 BASE STATION
100 TERMINAL APPARATUS
110 ANTENNA UNIT
120 WIRELESS COMMUNICATION UNIT
130 DISPLAY UNIT
140, 220 STORAGE UNIT
150, 230 CONTROL UNIT
200 INFORMATION PROCESSING APPARATUS
210 COMMUNICATION UNIT

1. A communication apparatus comprising:
a communication unit that forms a beam and performs communication with another communication apparatus; and
a control unit that acquires identification information of the beam used for the communication with the another communication apparatus, and
displays radiation information regarding at least one of a radiation angle or a radiation direction of the beam corresponding to the identification information on a display apparatus.

2. The communication apparatus according to claim 1, wherein in a case where the communication unit switches the beam to be used for the communication, the control unit acquires the identification information of the beam after switching by the communication unit, and switches to the radiation information corresponding to the identification information acquired and displays the radiation information on the display apparatus.

3. The communication apparatus according to claim 1, wherein the control unit displays an image indicating the radiation information on the display apparatus.

4. The communication apparatus according to claim 3, wherein the control unit displays the image being three-dimensional indicating the radiation information on the display apparatus.

5. The communication apparatus according to claim 3, wherein the control unit superimposes the image on a peripheral image and displays the image superimposed on the display apparatus.

6. The communication apparatus according to claim 1, wherein the control unit displays the radiation information and environment information regarding a radio wave environment of the another communication apparatus on the display apparatus.

7. The communication apparatus according to claim 1, wherein the identification information is an RxBeem ID.

8. The communication apparatus according to claim 1, wherein the control unit displays the radiation information associated with the identification information of the beam in advance on the display apparatus.

9. The communication apparatus according to claim 1, wherein the radiation information is associated with the identification information of the beam on a basis of a radiation angle of an antenna apparatus used by the communication unit to form the beam and at least one of an installation position or an angle of the antenna apparatus.

10. The communication apparatus according to claim 9, wherein the radiation angle of the antenna apparatus is estimated on a basis of phase shift amounts of a plurality of phase shifters included in the antenna apparatus.

11. The communication apparatus according to claim 1, wherein the radiation information is estimated by the communication unit measuring radiation power of an antenna apparatus used to form the beam.

12. The communication apparatus according to claim 1, wherein the radiation information is estimated on a basis of position information of the another communication apparatus, a radiation angle of a beam radiated by the another communication apparatus, and position information of the communication apparatus itself.

13. A communication method comprising:
forming a beam and performing communication with another communication apparatus;
acquiring identification information of the beam used for the communication with the another communication apparatus; and
displaying radiation information regarding at least one of a radiation angle or a radiation direction of the beam corresponding to the identification information on a display apparatus.
